(19) United States
(12) Patent Application Publication
(10) Pub. No.: US 2026/0095445 A1
(43) Pub. Date: Apr. 2, 2026

(54) METHOD AND APPARATUS FOR BIOMETRIC-BASED DISTRIBUTED AUTHENTICATION

(71) Applicant: Electronics and Telecommunications Research Institute, Daejeon (KR)

(72) Inventors: Kwan Tae CHO, Daejeon (KR); Sang Rae CHO, Okcheon-gun (KR); Soo Hyung KIM, Sejong-si (KR); Seok Hyun KIM, Daejeon (KR); Young Sam KIM, Daejeon (KR); Jong Hyouk NOH, Daejeon (KR); Young Seob CHO, Daejeon (KR); Jin Man CHO, Daejeon (KR); Seung Hun JIN, Daejeon (KR)

(21) Appl. No.: 19/331,957

(22) Filed: Sep. 17, 2025

(30) Foreign Application Priority Data
Oct. 2, 2024 (KR) 10-2024-0133915

(51) Int. Cl. H04L 9/40

(52) U.S. Cl. CPC H04L 63/0861

(57) ABSTRACT

A method and an apparatus for biometric-based distributed authentication. According to an aspect of the disclosure, there is provided a distributed authentication apparatus, in which a user terminal and N servers collaborate to perform user authentication, the apparatus including: a second data receiver configured to receive second biometric input data related to biometric information input by a user to the user terminal; a verification fragment value acquirer, configured to receive a first verification fragment value associated with the user terminal and acquire respective server verification fragment values from each of the N servers; a data verifier configured to perform user authentication using the second biometric input data, the first verification fragment value, and the respective server verification fragment values.

### CROSS-REFERENCE TO RELATED APPLICATION

The present application claims priority to Korean Patent Application No. 10-2024-0133915, filed on Oct. 2, 2024 in the Korea Intellectual Property Office, the entire contents of which are incorporated herein by reference.

### TECHNICAL FIELD

The present disclosure relates to a method and apparatus for biometric-based distributed authentication.

### BACKGROUND

The content described below merely provides background information related to the present embodiment and does not constitute the prior art.

A user authentication technology using biometric information (hereinafter referred to as a biometric authentication technology) has become one of the main user authentication means due to high security and convenience.

Such biometric authentication technology has many advantages, and its importance is further highlighted as the penetration rate of smartphones increases.

Since the biometric information is unique to each individual, it is difficult to replicate or steal. For example, user authentication techniques using fingerprints, iris, facial information, etc., are based on unique characteristics of the biometric that are not shared with others.

In addition, since the biometric information does not need to be stored by the user and always exists in the user, it is not necessary to carry a separate security token or security card. That is, it is possible to quickly authenticate by simply placing a finger on the smartphone or illuminating the face on the camera.

In addition, the biometric authentication technology does not have the hassle of having to change periodically like the password used in the ID/password-based user authentication technology, and there are no security vulnerabilities that may occur due to the speculative password or the reuse of the same password.

The nature of this biometric authentication technology provides convenience to the user while at the same time reducing authentication failures and increasing security. Furthermore, the biometric authentication technology may relatively easily enhance security by combining various biometric information. For example, a multimodal user authentication technique that uses facial recognition and fingerprint recognition together may be more secure than using single biometric information.

The biometric authentication technology having such characteristics is currently adopted as a representative user authentication technology in various service fields such as finance, medical care, access control, and smartphone security, and plays an important role as an essential user authentication means.

The biometric authentication technology has such distinct advantages, but on the one hand has major limitations. As already mentioned, the biometric information is unique information of the individual that cannot be changed. Therefore, if biometric information or user credentials derived from biometric information (hereinafter referred to as biometric credentials) are leaked, it may not be possible to change to new information like a password or restore to a normal state, which may lead to serious privacy issues.

### SUMMARY

An object of the present disclosure is to provide a method and apparatus for biometric-based distributed authentication.

The problems to be solved by the disclosure are not limited to the problems mentioned above, and other problems not mentioned will be clearly understood by a person skilled in the art from the following description.

According to an aspect of the disclosure, there is provided a distributed authentication apparatus, in which a user terminal and N servers collaborate to perform user authentication, the apparatus including: a second data receiver configured to receive second biometric input data related to biometric information input by a user to the user terminal; a verification fragment value acquirer, configured to receive a first verification fragment value associated with the user terminal and acquire respective server verification fragment values from each of the N servers; a data verifier configured to perform user authentication using the second biometric input data, the first verification fragment value, and the respective server verification fragment values.

According to other aspect of the disclosure, there is provided a distributed authentication apparatus for performing user authentication in collaboration with N servers, including: a first data receiver configured to receive first biometric input data relating to first biometric information of a user; a first random number generator configured to generate N random numbers for the N servers; and a first verification fragment value generator configured to receive respective server-generated terminal random numbers from each of the N servers and to calculate the first verification fragment value using the first biometric input data, the N random numbers, and the respective server-generated terminal random numbers.

According to other aspect of the disclosure, there is provided a distributed authentication method of performing a distributed authentication by a distributed authentication apparatus in which a user terminal and N servers collaborate to perform user authentication, the method including: receiving a second biometric input data related to biometric information input by a user to the user terminal; receiving a first verification fragment value related to the user terminal and acquiring respective server verification fragment values from each of the N servers; performing user authentication using the second biometric input data, the first verification fragment value, and the respective server verification fragment values.

As described above, according to the embodiment of the disclosure, there is an effect of distributing and storing user biometric credentials in a plurality of servers in a cryptographically secure manner through multi party computation (MPC).

In addition, since no specific party leads the user authentication process at the time of user authentication, the user authentication process may be securely performed without a trusted third party (TTP).

Further, each of the service provider servers participating in the user authentication participates in the user authentication process without knowing any information about the user biometric credentials distributed and stored in another service provider server, so that only the success or failure of the user's authentication is acquired as a result value through the multi party computation between a plurality of service provider servers, which has the effect that even if an attacker hacks a certain server, no useful information about the user's biometric credentials may be acquired.

The effects of the disclosure are not limited to the effects mentioned above, and other effects not mentioned will be clearly understood by a person skilled in the art from the following description.

### BRIEF DESCRIPTION OF THE DRAWINGS

FIG. 1 is a diagram illustrating a configuration diagram of a system for biometric-based distributed authentication.

FIG. 2 is a diagram illustrating a configuration of a first distributed authentication apparatus and any one of second distributed authentication apparatuses according to an embodiment of the disclosure.

FIG. 3 is a diagram illustrating an additional configuration of the first distributed authentication apparatus 210 and an additional configuration of any one of the second distributed authentication apparatus 220, respectively.

FIG. 4 is a flowchart illustrating a distributed authentication method according to an embodiment of the disclosure.

FIG. 5 is a flowchart illustrating a distributed authentication method according to another embodiment of the disclosure.

### DETAILED DESCRIPTION

Hereinafter, some embodiments of the disclosure will be described in detail with reference to illustrative drawings. It should be noted that, in adding an identification code to the components in each figure, the same components have the same code as much as possible even if they are indicated in other figures. In addition, in the description of the disclosure, when it is determined that a specific description of a related known configuration or function may obscure the gist of the disclosure, a detailed description thereof will be omitted.

In describing the components of the embodiments according to the disclosure, reference numerals such as first, second, i), ii), a), and b) may be used. These reference numerals are merely used to distinguish the components from other components, and the nature, sequence, order, and the like of the components are not limited by the reference numerals. In the specification, when a part ‘includes’ or ‘contains’ a certain component, it means that other components may be further included instead of excluding other components unless explicitly stated to the contrary.

The detailed description set forth below in conjunction with the appended drawings is intended to describe exemplary embodiments of the disclosure and is not intended to represent the only embodiments in which the disclosure may be practiced.

The user biometric credentials used by the biometric authentication means may be stored and managed in one service provider server or a secure storage.

If a malicious attacker hacks a service provider server and successfully acquires the biometric credentials of a specific user (service subscriber) stored therein, due to the unique characteristics of the biometric, the user may easily disguise himself/herself as the user by logging in to a number of other services subscribed by using the same biometric, which in turn may lead to more personal information leakage and invasion of privacy of the user.

If an attacker acquires biometric credentials for a large number of users through server hacking, the damage will be even greater, resulting in massive damage such as massive leakage of personal information of all service subscribers, resulting legal sanctions, suspension of operation of the service, and large number of service subscribers leaving, which will eventually lead to a decrease in trust of the service provider and a large loss.

In order to reduce the above-mentioned damage, the service provider may consider, as an alternative, a user-distributed authentication technology in which the biometric credentials of the user are distributed and stored in multiple servers instead of one server.

Such a user distributed authentication technique does not allow an attacker to acquire the biometric credentials of an intact user unless the attacker hacks all service provider servers or secure storage that are distributedly stored by the user.

However, security vulnerabilities also exist in such user distributed authentication technologies.

Even if the biometric credentials of the user are stored separately in multiple servers, in order to authenticate the logging-in user, any specific service provider server or a trusted third-party user authentication server must collect all the stored biometric credentials distributed from the multiple servers, recover them to the original biometric credentials, and calculate a distance value from the biometric credential of the user newly entered for logging-in.

If the attacker succeeds in hacking the user authentication server or if there is a user authentication server manager with malicious intent, the user's biometric credentials may be exposed as-is, which will cause the same damage as if they were stored on a single server rather than multiple servers.

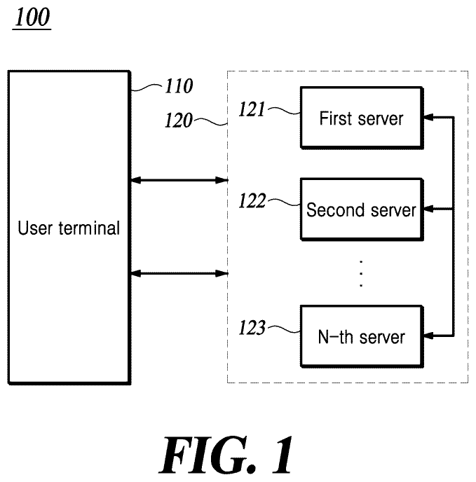

FIG. 1 is a diagram illustrating a configuration diagram of a system for biometric-based distributed authentication.

The system for biometric-based distributed authentication 100 includes a user terminal 110 and a server group 120.

The server group 120 includes at least one server (e.g., the first server 121, the second server 122, . . . and the Nth server 123 as N servers).

The user may perform membership registration for a service provided by the service provider using the user terminal 110.

The user terminal 110 distributes and registers the first biometric information to be registered by the user to the multiple servers 121, 122, 123 at the time of membership registration.

These N servers 121, 122, 123 may be operated by a single or multiple service providers.

Each of the servers 121, 122, 123 provides a multi party computation function to be described later.

Intercommunication is possible between the respective servers 121, 122, 123 and between the respective server 121, 122, 123 and the user terminal 110 for multi party computation.

In the present embodiment, when the user logs in to the user terminal 110, the user terminal 110 and each of the N servers 121, 122, 123 cooperatively calculate a distance value and compare it with a given threshold to see how similar the second biometric information newly input by the user using the user terminal 110 for user authentication and the first biometric information distributed and registered at the time of membership registration are to each other. After comparing the distance value with the threshold, each of the servers 121, 122, 123 receives whether user authentication is successful.

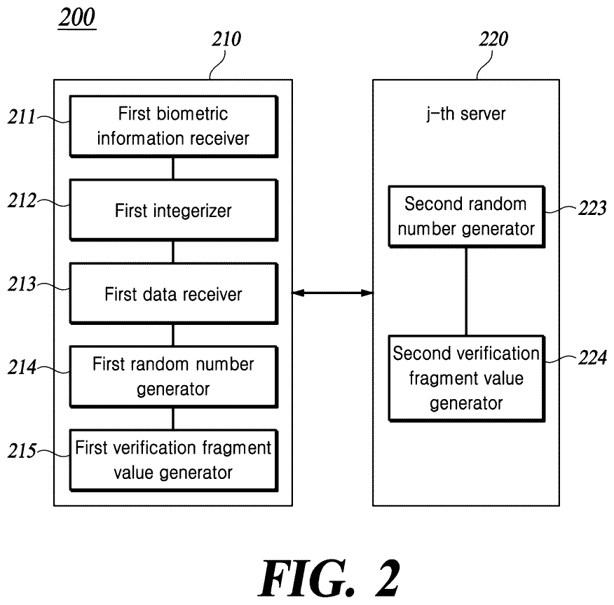

FIG. 2 is a diagram illustrating a configuration of a first distributed authentication apparatus and any one of second distributed authentication apparatuses according to an embodiment of the disclosure.

The first distributed authentication apparatus 210 may be implemented in the user terminal 110, but is not necessarily limited thereto.

As shown in FIG. 2, the first distributed authentication apparatus 210 may be implemented to include a first biometric information acquirer 211, a first integerizer 212, a first data receiver 213, a first random number generator 214, and a first verification fragment value generator 215. The first distributed authentication apparatus 210 may be implemented by omitting some of the components in FIG. 2 or by adding other components not shown in FIG. 2.

The second distributed authentication apparatus 220 is implemented in each of the servers 121, 122, 123, and in the present embodiment, for easy understanding, the second distributed authentication apparatus will be described assuming that it corresponds to the j-th server (where 1≤j≤N is an integer).

In practice, the second distributed authentication apparatus 220 may be implemented in each of the N servers 121, 122, 123. The distributed registration processing procedure and the distributed authentication procedure in the present embodiment are respectively performed in collaboration with the first distributed authentication apparatus 210 and the N servers 121, 122, 123.

The second distributed authentication apparatus 220 may be implemented to include a second random number generator 223, and a second verification fragment value generator 224. The second distributed authentication apparatus 220 may be implemented by omitting some of the components in FIG. 2 or by adding other components not shown in FIG. 2.

Hereinafter, a procedure for the distributed registration processing of the first biometric information will be described.

The first biometric information acquirer 211 receives the first biometric information of the user input by the user using the input device of the user terminal 110, and acquires the first biometric feature data x from the received first biometric information.

For biometric-based user authentication, the first biometric information acquirer 211 acquires the first biometric feature data x using an artificial intelligence model using various biometric information such as a face, a fingerprint ridge pattern, an iris pattern, a vein pattern, a voice signal, and a dynamic characteristic of a signature as learning data.

The first biometric feature data x acquired herein may be composed of a multi-dimensional real-valued vector.

The first integerizer 212 integerizes the first biometric feature data x to generate first integerized data x₀.

The first integerizer 212 converts the first biometric feature data x, such as a multi-dimensional real-valued vector, into first integerized data x₀, such as a multi-dimensional integer vector.

The first biometric feature data x in the form of a real number is converted into the first integerized data x₀, thereby enabling faster multi party computation processing.

The first integerization data x₀ may be input as first biometric input data to the first verification fragment value generator 215, which will be described later.

The first verification fragment value generator 215 may perform a computation for a boolean circuit and a computation for an arithmetic circuit.

The boolean circuit computation is required for computation of real-valued data, and the boolean circuit computation provides various computation functions compared to arithmetic circuit computation, but the computation speed is relatively slow.

In the present embodiment, the first verification fragment value generator 215 may use only the arithmetic circuit computation without using the boolean circuit computation. When the arithmetic circuit computation is used, generation of the first integerization data x₀ by the first integerizer 212 may be required.

The first data receiver 213 receives the first biometric feature data x or the first integerization data x₀ as the first biometric data.

According to an embodiment, the first integerizer 212 may be omitted, and in this case, the first biometric feature data x may be input to the first data receiver 213 as the first biometric data.

In the following description, it is assumed that the first biometric data is the first integerized data x₀.

The first random number generator 214 generates N terminal-generated random numbers (hereinafter, referred to as terminal-generated j-th server random numbers) x_{0,i} for each of the N i-th servers 121, 122, 123, as shown in Equation 1.

$${x}_{0 , i} ∈ [ 0 , {2}^{k} - 1 ] , where 1 \leq i \leq N \qquad [ Equation 1 ]$$

Wherein, k is a security parameter, and is used to define a range of generated random numbers.

In Equation 1, x_{0,1} is a terminal-generated first server random number for the first server 121, x_{0,2} is a terminal-generated second server random number for a second server 122, and x_{0,3} is a terminal-generated third server random number for third server 123.

The second random number generator 223 of each of the N j-th servers 121, 122, 123 including the first server 121 generates N random numbers (hereinafter, referred to as server-generated random numbers) r_{j,i} (where 0≤i≤N, i≠j), respectively. That is, the first server 121 also generates N server-generated random numbers, the second server 122 also generates N server-generated random numbers, and the third server 123 also generates N server-generated random numbers.

Herein, the N server-generated random numbers generated by the second random number generator 223 of the N servers 121, 122, 123 respectively mean the server-generated random number for the user terminal 110 (hereinafter, referred to as a server-generated terminal random number) and the N−1 server-generated random numbers for the other (N−1) servers (hereinafter, referred as a server-generated other server random number).

In other words, among the server-generated random numbers r_{j,i} of the j-th servers 121, 122, 123, r_{j,0} is a j-th server-generated terminal random number for the user terminal 110 of the the j-th server 121, 122, 123, and the remaining random number r_{j,i} (where 1≤i≤N, i≠j) is a j-th-server-generated i-th server random number for N−1 other i-th servers except the j-th servers 121, 122, 123 themselves.

For example, the first server 121 may generate N server-generated random numbers [r_{1,i}∈[0,2^{k}−1], where 0≤i≤N, i≠1)], the second server 122 may generate N other-server-generated random numbers [r_{2,i}∈[0,2^{k}−1], where 0≤i≤N, i≠2)], and the N-th server 123 may generate N still-other-server-generated random number [r_{N,i}∈[0,2^{k}−1], where 0≤i≤N, i≠N].

The first verification fragment value generator 215 receives the first integerization data x₀ from the first integerizer 212, and receives the N terminal-generated server random numbers x_{0,i} from the first random number generator 214.

The first verification fragment value generator 215 calculates the terminal-generated random sum value tr according to Equation 2.

$$tr = {\sum }_{i = 1}^{N} {x}_{0 , i} \qquad [ Equation 2 ]$$

The first verification fragment value generator 215 calculate the terminal residual value x_{0,0} by subtracting the terminal-generated random number sum value tr from the first integerized data x₀, as shown in Equation 3.

$${x}_{0 , 0} = {x}_{0} - tr \qquad [ Equation 3 ]$$

The first verification fragment value generator 215 receives the j-th server-generated terminal random number r_{j,0} (where 1≤j≤N) from each of the N servers 121, 122, 123, respectively.

The first verification fragment value generator 215 calculates a server-generated terminal random number sum ssr by summing the respective j-th server-generated terminal random numbers to each other according to Equation 4.

$$ssr = {\sum }_{j = 1}^{N} {r}_{j , 0} \qquad [ Equation 4 ]$$

The first verification fragment value generator 215 calculates the terminal verification fragment value so by subtracting the server-generated terminal random numbers sum ssr from the terminal residual value x_{0,0}, as shown in Equation 5.

The first verification fragment value generator 215 stores the calculated terminal verification fragment value so in a database of the first distributed authentication apparatus 210.

Herein, the stored terminal verification fragment value so is defined as a first verification fragment value.

$${s}_{0} = {x}_{0 , 0} - ssr \qquad [ Equation 5 ]$$

In each of the N j-th servers 121, 122, 123, the second verification fragment value generator 224 receives N−1 j-th server-generated other server random numbers r_{j,i} (where 1≤i≤N, i≠j) from the second random number generator 223.

Further, the second verification fragment value generator 224 receives the corresponding terminal-generated server random number x_{0,i} (where 1≤i≤N) from the first distributed authentication apparatus 210. Here, x_{0,j} is received because it is a terminal-generated server random number for the j-th server.

In addition, the second verification fragment value generator 224 calculates the j-th server-generated random sum rⱼ as follows.

$${r}_{j} = {\sum }_{i = 0 , i \neq j}^{N} {r}_{j , i} \qquad [ Equation 6 ]$$

Wherein, rⱼ is the value obtained by summing the j-th server-generated terminal random number and the j-th-server-generated i-th server random number for N−1 other i-th servers except the j-th servers 121, 122, 123 themselves.

The second verification fragment value generator 224 calculates the other-server-generated j-server random number sum Oⱼ, as shown in Equation 7.

$${O}_{j} = {\sum }_{i = 1 , i \neq j}^{N} {r}_{j , i} {r}_{i , j} \qquad [ Equation 7 ]$$

The second verification fragment value generator 224 calculates a j-th server verification fragment value sⱼ by adding the terminal-generated j-th server random number x_{0,j} and the j-th server-generated random sum rⱼ and subtracting the other-server-generated j-th server random sum Oⱼ, as shown in Equation 8.

$${s}_{j} = {x}_{0 , j} + {r}_{j} - {O}_{j} \qquad [ Equation 8 ]$$

The second verification fragment value generator 224 stores the calculated j-th server verification fragment value sⱼ in the database of the second distributed authentication apparatus 220.

Therefore, the respective j-th server verification fragment value sⱼ corresponding to each of all N servers 121, 122, 123 is stored in each server 121, 122, 123.

Here, the j-th server verification fragment value sⱼ is defined as a j-th server verification fragment value.

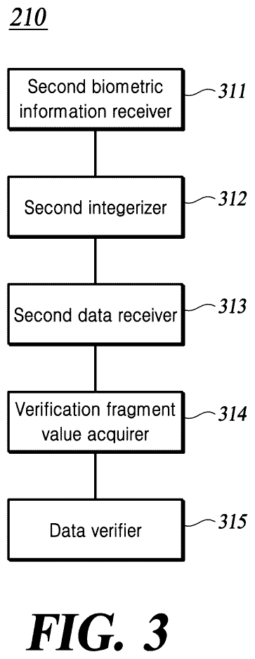

FIG. 3 is a diagram illustrating an additional configuration of the first distributed authentication apparatus 210 and an additional configuration of any one of the second distributed authentication apparatus 220, respectively.

The configuration of FIG. 3 is for biometric distributed authentication that may be executed when a user logs in to a service.

In the present embodiment, for easy understanding, the biometric distributed authentication operation is described with reference to the first distributed authentication apparatus 210 and the j-th server 220, but substantially all N servers 121, 122, 123 participate in the biometric distributed authentication.

That is, the biometric distributed authentication processing procedure performed between the first distributed authentication apparatus 210 and the j-th server 220 is performed by performing multi party computation processing simultaneously by all the participants (the first distributed authentication apparatus 210 and the N servers).

As shown in FIG. 3, the first distributed authentication apparatus 210 may include a second biometric information acquirer 311, a second integerizer 312, a second data receiver 313, a verification fragment value acquirer 314, and a data verifier 315.

The second biometric information acquirer 311 receives the second biometric information of the user input by the user using the input device of the user terminal 110 for login, and acquires the second biometric feature data x′ from the received second biometric information.

The second biometric information acquirer 311 acquires the second biometric feature data x′ using the artificial intelligence model using various biometric information such as the face, the fingerprint ridge pattern, the iris pattern, the vein pattern, the voice signal, and the dynamic characteristic of the signature as learning data.

The second biometric feature data x′ acquired herein may be composed of the multi-dimensional real-valued vector.

The second integerizer 312 integerizes the second biometric feature data x to generate second integerized data x₀′.

The second integerizer 312 converts the second biometric feature data x′, such as a multi-dimensional real-valued vector, into second integerized data x₀′, such as a multi-dimensional integer vector.

The second biometric feature data x′ in the form of a real number is converted into the second integerized data x₀′, thereby enabling faster multi party computation processing.

The second data receiver 313 receives the second biometric feature data x′ or the second integerization data x₀′ as biometric data.

According to an embodiment, the second integerizer 312 may be omitted, and in this case, the second biometric feature data x′ may be input to the second data receiver 313 as biometric data.

In the following description, it is assumed that the biometric data is the second integerized data x₀′.

The verification fragment value acquirer 314 acquires the first verification fragment value so.

In addition, the verification fragment value acquirer 314 acquires each j-th server verification fragment value sⱼ from each of the j-th servers 121, 122, 123.

The data verifier 315 restore the verification fragment sum value as the first integerized data x₀ by summing the first verification fragment value so and the respective j-th server verification fragment values sⱼ, as shown in Equation 9.

$${x}_{0} = {\sum }_{j = 0}^{N} {s}_{j} \qquad [ Equation 9 ]$$

The data verifier 315 calculates a similarity (or a distance value) between the restored first integerized data x₀ and the second biometric input data x₀′.

Herein, the similarity may be calculated using various algorithms for computing distance values, such as squared Euclidean distance, cosine distance, and angular distance.

The data verifier 315 compares the derived similarity with a predefined threshold to determine whether user authentication is successful. That is, the data verifier 315 determines that user authentication is successful if the derived similarity is greater than or equal to the predefined threshold, and determines that user authentication fails if the similarity is less than the predefined threshold.

The data verifier 315 delivers the user authentication success/failure result values to the N servers 121, 122, 123 excluding the user terminal 110.

The server to which the user has connected among the servers 121, 122, 123 to which the authentication result value has been distributed from the data verifier 315 processes the authentication result value and transmits the authentication result to the user terminal 110.

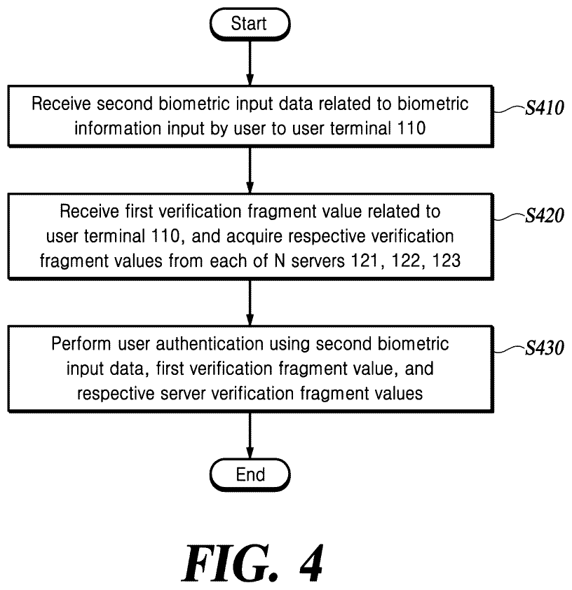

FIG. 4 is a flowchart illustrating a distributed authentication method according to an embodiment of the disclosure.

The second data receiver 313 performs receiving a second biometric input data related to the biometric information input by the user to the user terminal 110 (S410).

The verification fragment value acquirer 314 receives the first verification fragment value related to the user terminal 110 and performs acquiring respective server verification fragment values from each of the N servers 121, 122, 123 (S420).

The data verifier 315 performs performing user authentication using the second biometric input data, the first verification fragment value, and respective server verification fragment values (S430).

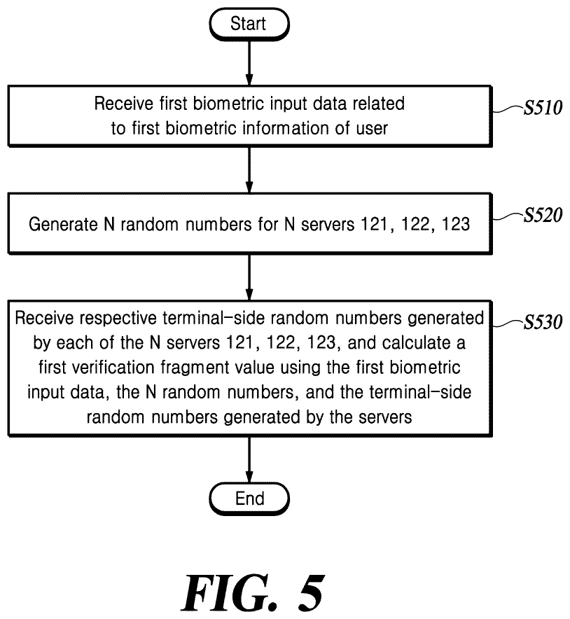

FIG. 5 is a flowchart illustrating a distributed authentication method according to another embodiment of the disclosure.

The first data receiver 213 performs receiving first biometric input data related to the first biometric information of the user (S510).

The first random number generator 214 performs generating N random numbers for the N servers 121, 122, 123 (S520).

The first verification fragment value generator 215 receives respective server-generated terminal random numbers from each of the N servers 121, 122, 123, and performs calculating the first verification fragment value using the first biometric input data, the N random numbers, and respective server-generated terminal random numbers (S530).

Among existing inventions related to a user authentication method, there is an invention in which a user biometric verification value (that is, a value obtained by cryptographically safely deriving a biometric information value using a unidirectional hash function or the like) is simply divided, and then the divided biometric verification values are mixed and stored in a distributed manner.

However, this approach may expose some of the user biometric validation values as-is when a distributed stored server or storage is hacked.

In the disclosure, since the biometric information (or the biometric verification value) is not simply divided but the cryptographically randomized value (hereinafter, the biometric verification fragment value) is distributed and stored by using a multi party computation, the attacker cannot obtain even 1-bit information about the biometric verification value of the user unless all the distributed and stored servers or storages are hacked.

In addition, even in user authentication, since the biometric verification value is verified through the multi party computation on values distributed and stored in random numbers, even if the attacker succeeds in any specific server hacking, the attacker cannot obtain meaningful information about the original biometric verification value.

At least some components described in the exemplary embodiments of the disclosure may be implemented as a hardware element including at least one or a combination of a digital signal processor (DSP), a processor, a controller, an application-specific IC (ASIC), a programmable logic device (FPGA, etc.), and other electronic devices. In addition, at least some functions or processes described in the exemplary embodiments may be implemented in software, and the software may be stored in a recording medium. At least some components, functions, and processes described in the exemplary embodiments of the disclosure may be implemented by a combination of hardware and software.

The method according to the exemplary embodiments of the disclosure may be written as a program that may be executed in a computer, and may also be implemented in various recording media such as a magnetic storage medium, an optical reading medium, and a digital storage medium.

Implementations of the various techniques described herein may be implemented in digital electronic circuitry, or in computer hardware, firmware, software, or combinations thereof. Implementations may be implemented as a computer program product, i.e., a computer program tangibly embodied in an information carrier, e.g., a machine-readable storage device (computer-readable medium) or a propagated signal, for processing by, or to control the operation of, a data processing apparatus, e.g, a programmable processor, a computer, or multiple computers. The computer program, such as the computer program(s) described above, may be written in any form of programming language, including compiled or interpreted languages, and may be deployed in any form, including as a standalone program or as a module, component, subroutine, or other unit suitable for use in a computing environment. The computer program may be deployed to be processed on one computer or multiple computers at one site or distributed across multiple sites and interconnected by a communication network.

Processors suitable for processing the computer program include, by way of example, both general-purpose and special-purpose microprocessors, and any one or more processors of any kind of digital computer. In general, a processor will receive instructions and data from a read-only memory or a random access memory or both. Elements of a computer may include at least one processor executing instructions and one or more memory devices storing instructions and data. In general, a computer may include, or be coupled to receive data from, or transmit data to, or both, one or more mass storage devices that store data, e.g., magnetic, magneto-optical disks, or optical disks. Information suitable for embodying computer program instructions and data carriers include, for example, semiconductor memory devices such as magnetic media such as hard disks, floppy disks, and magnetic tapes, optical media such as Compact disk read only memory (CD-ROM), digital video disk (DVD), magneto-optical media such as floptical disk, read only memory (ROM), random access memory (RAM), flash memory, erasable programmable ROM (EPROM), electrically erasable programmable ROM (EEPROM), and the like. The processor and memory may be supplemented by, or included in, special purpose logic circuitry.

The processor may perform an operating system and a software application performed on the operating system. Further, the processor device may access, store, manipulate, process, and generate data in response to execution of the software. For ease of understanding, a processor device may be described as one being used, but those skilled in the art will recognize that the processor device may include a plurality of processing elements and/or a plurality of types of processing elements. For example, the processor device may include a plurality of processors or one processor and one controller. Other processing configurations are also possible, such as parallel processors.

In addition, non-transitory computer-readable media may be any available media that may be accessed by a computer, and may include both computer storage media and transmission media.

Although this specification contains many specific implementation details, these should not be construed as limiting on the scope of any invention or claim, but rather as a description of features that may be specific to a particular embodiment of a particular invention. Certain features described herein in the context of separate embodiments may be implemented in combination in a single embodiment. Conversely, various features described in the context of a single embodiment may also be implemented in multiple embodiments individually or in any suitable subcombination. Furthermore, while features may operate in a particular combination and be initially depicted as so claimed, one or more features from a claimed combination may in some cases be excluded from the combination, and the claimed combination may be altered to a subcombination or variation of a subcombination.

Similarly, while operations are depicted in the drawings in a particular order, this should not be understood as requiring that such operations be performed in the particular order shown or in sequential order, or that all illustrated operations be performed, in order to achieve a desirable result. In certain cases, multitasking and parallel processing may be advantageous. It should also be understood that the separation of the various device components of the embodiments described above should not be understood as requiring such separation in all embodiments, and that the described program components and devices may generally be integrated together in a single software product or packaged in multiple software products.

It should be noted that the embodiments of the disclosure disclosed in this specification and the drawings merely provide specific examples for better understanding, and are not intended to limit the scope of the disclosure. It is obvious to a person skilled in the art that other modifications based on the technical idea of the disclosure may be implemented in addition to the embodiments disclosed herein.

The protection scope of the present embodiment should be interpreted by the following claims, and all technical ideas falling within the scope equivalent thereto should be interpreted as being included in the scope of rights of the present embodiment.

What is claimed is:

1. A distributed authentication apparatus, in which a user terminal and N servers collaborate to perform user authentication, the apparatus comprising:
a second data receiver configured to receive second biometric input data related to biometric information input by a user to the user terminal;
a verification fragment value acquirer, configured to receive a first verification fragment value associated with the user terminal and acquire respective server verification fragment values from each of the N servers;
a data verifier configured to perform user authentication using the second biometric input data, the first verification fragment value, and the respective server verification fragment values.

2. The distributed authentication apparatus of claim 1, wherein
the data verifier is configured to:
perform the user authentication by acquiring a verification fragment sum value obtained by summing the first verification fragment value and the respective server verification fragment values.

3. The distributed authentication apparatus of claim 2, wherein
the data verifier is configured to:
perform the user authentication by calculating a similarity between the verification fragment sum value and the second biometric input data.

4. The distributed authentication apparatus of claim 1, further comprising:
a first data receiver configured to receive first biometric input data relating to the first biometric information of the user;
a first random number generator configured to generate N random numbers for the N servers; and
a first verification fragment value generator configured to receive respective server-generated terminal random numbers from each of the N servers, and calculate the first verification fragment value using the first biometric input data, the N random numbers, and the respective server-generated terminal random numbers.

5. The distributed authentication apparatus of claim 4, wherein
the first verification fragment value generator is configured to:
calculate a terminal-generated random number sum value by summing the N random numbers; calculate a terminal residual value by subtracting the terminal-generated random number sum value from the first biometric input data; calculate a server-generated terminal random number sum by summing the respective server-generated terminal random numbers; and calculate a first verification fragment value by subtracting the server-generated terminal random number sum from the terminal residual value.

6. A distributed authentication apparatus for performing user authentication in collaboration with N servers, comprising:
a first data receiver configured to receive first biometric input data relating to first biometric information of a user;
a first random number generator configured to generate N random numbers for the N servers; and
a first verification fragment value generator configured to receive respective server-generated terminal random numbers from each of the N servers and to calculate the first verification fragment value using the first biometric input data, the N random numbers, and the respective server-generated terminal random numbers.

7. The distributed authentication apparatus of claim 6, wherein
the first verification fragment value generator is configured to:
calculate a terminal-generated random number sum value by summing the N random numbers; calculate a terminal residual value by subtracting the terminal-generated random number sum value from the first biometric input data; calculate a server-generated terminal random number sum by summing the respective server-generated terminal random numbers; and calculate a first verification fragment value by subtracting the server-generated terminal random number sum from the terminal residual value.

8. A distributed authentication method of performing a distributed authentication by a distributed authentication apparatus in which a user terminal and N servers collaborate to perform user authentication, the method comprising:
receiving a second biometric input data related to biometric information input by a user to the user terminal;
receiving a first verification fragment value related to the user terminal and acquiring respective server verification fragment values from each of the N servers;
performing user authentication using the second biometric input data, the first verification fragment value, and the respective server verification fragment values.

9. The distributed authentication method of claim 8, wherein
the performing user authentication using the second biometric input data, the first verification fragment value, and the respective server verification fragment values comprises:
performing the user authentication by acquiring a verification fragment sum value obtained by summing the first verification fragment value and the respective server verification fragment values.

10. The distributed authentication method of claim 9, wherein
the performing user authentication using the second biometric input data, the first verification fragment value, and the respective server verification fragment values comprises:
performing the user authentication by calculating a similarity between the verification fragment sum value and the biometric input data.

11. The distributed authentication method of claim 8, further comprising:
receiving a first biometric input data related to the first biometric information of the user;
generating N random numbers for the N servers; and
receiving respective server-generated terminal random numbers from each of the N servers, and calculating the first verification fragment value using the first biometric input data, the N random numbers, and the respective server-generated terminal random numbers.

12. The distributed authentication method of claim 11, wherein:
receiving respective server-generated terminal random numbers from each of the N servers, and calculating the first verification fragment value using the first biometric input data, the N random numbers, and the respective server-generated terminal random numbers comprises:
calculating a terminal-generated random number sum value by summing the N random numbers; calculating a terminal residual value by subtracting the terminal-generated random number sum value from the first biometric input data; calculating a server-generated terminal random number sum by summing the respective server-generated terminal random numbers; and calculating the first verification fragment value by subtracting the server-generated terminal random number sum from the terminal residual value.

13. The distributed authentication method of claim 8, wherein
generating, by one server of the N servers, random numbers for the user terminal and random numbers for the N−1 servers, respectively;
calculating a server-generated random number sum by adding the random number for the user terminal and the respective random numbers for the N−1 servers;
receiving a terminal-generated server random number from the user terminal and receiving respective other-server-generated server random numbers from the N−1 servers;
calculating the server verification fragment value using each of the other-server-generated server random numbers, the terminal-generated server random number, and the server-generated random number sum.

14. The distributed authentication method of claim 13, wherein
the calculating the server verification fragment value using each of the other-server-generated server random numbers, the terminal-generated server random number, and the server-generated random number sum comprises:
calculating an other-server-generated server random number sum by summing the respective other-server-generated server random numbers, and adding the terminal-generated server random number and the server-generated random number sum and subtracting the other-server-generated server random number sum to calculate the server verification fragment value.
